(19) United States
(12) Patent Application Publication
(10) Pub. No.: US 2016/0285794 A1
(43) Pub. Date: Sep. 29, 2016

(54) HIGH EFFICIENCY DATA COMMUNICATION SYSTEM

(71) Applicant: Syntel, Inc., Troy, MI (US)

(72) Inventor: Narendra S. Naidu, Pune Maharashtra (IN)

(21) Appl. No.: 14/671,232

(22) Filed: Mar. 27, 2015

(51) Int. Cl. H04L 12/58

(52) U.S. Cl. CPC H04L 51/046

(57) ABSTRACT

A data communication system may include a computer server that may include a processor, a memory, and a computer program encoded on said memory. The computer program may be configured to implement system logic. The system logic may include a listening module stored in a first part of the memory and configured to monitory a plurality of different communication channels for data request messages, a message queue stored in a second part of the memory and including asynchronously stored data request messages received from the listening module, and a foundation framework stored in a third part of the memory. The foundation framework may be configured to obtain data request messages from the message queue and process, execute, and respond to the obtained data request messages.

### BACKGROUND

a. Technical Field

The present disclosure relates to a system, method, and article of manufacture configured to provide high efficiency communications, including between an organization and its client and/or customers.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

Communications via computer networks, including the internet, are becoming more common and new communication applications are being developed, which may create new problems that are not applicable to conventional communication systems. For example, network communications may be convenient, but the data contained in such communications is often processed inefficiently. Inefficient communications may be caused, at least in part by, data being received via a variety of communication channels/applications that may each use different formats and such formats are constantly changing. Also, messages may request different types of information, arrive from various different sources, and processing each may accomplished via a single rigid system and/or via disparate systems and methods that are not set up to communicate with each other.

There is, therefore, a need for solutions that allow for more efficient communications, such as computer network communications. The foregoing discussion is intended only to illustrate aspects of the present field and should not be taken as a disavowal of claim scope.

### SUMMARY

In embodiments, a data communication system may comprise a computer server that may comprise a processor, a memory; and a computer program encoded on said memory. The computer program may configured to implement system logic that may include a listening module that may be stored in a first part of the memory and may be configured to monitor a plurality of different electronic communication channels for data request messages. System logic may include a message queue that may be stored in a second part of the memory and may include asynchronously stored data request messages received from the listening module. System logic may include a foundation framework that may be stored in a third part of the memory. The foundation framework may be configured to obtain data request messages from the message queue and process, execute, and/or respond to the obtained data request messages.

In embodiments, a method for high efficiency data communications via a computer network may include providing a computer server including a processor and a memory coupled to the processor. The method may include receiving, via a listening module executed by the processor and stored in a first part of the memory, a plurality of unrelated data request messages from a plurality of different electronic communication channels of the computer network. The method may include asynchronously storing the plurality of data request messages in a message queue stored in a second part of the memory. The method may include obtaining data requested in the data request messages via a foundation framework executed by the electronic processor and stored in a third part of the memory. The method may include sending, via a response module executed by the electronic processor and stored in a fourth part of the memory, responses to the plurality of data request messages via one or more of the plurality of different communication channels.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1A is block diagram showing an embodiment of a high efficiency data communication system according to the present disclosure.

FIG. 1B is flow diagram showing an embodiment of a high efficiency data communication system according to the present disclosure.

FIGS. 2A and 2B are block diagrams showing portions of embodiments of a high efficiency data communication system according to the present disclosure.

FIG. 3 is a flow diagram illustrating aspects of an embodiment of a message processor of a high efficiency data communication system according to the present disclosure.

FIGS. 4-6 are block diagrams showing embodiments of a high efficiency data communication system according to the present disclosure.

### DETAILED DESCRIPTION

Before proceeding to a detailed description of embodiments of the instant disclosure, a general overview of its operation will first be set forth. As described in the Background, data communication, such as via the internet, is often inefficient.

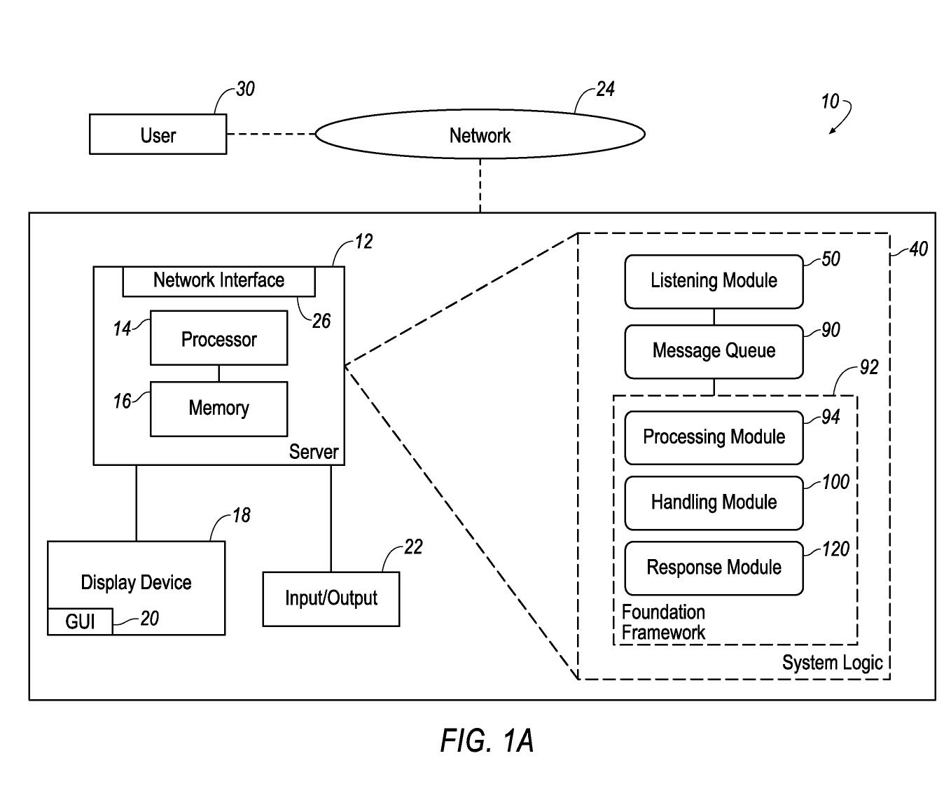

Referring now to the drawings, wherein like reference numerals are used to identify identical or similar components in the various views, FIG. 1 is a diagrammatic and block diagram view of an embodiment of a high efficiency data communication system 10. In embodiments, system 10 may include a server 12 (e.g., a computer server) and/or may include a processor 14 (e.g., an electronic processor) and an memory 16 (e.g., an electronic memory). A system logic 40 may be stored in memory 16 and may include listening module 50, a message queue 90, and/or a foundation framework 92.

In embodiments, server 12 may be configured to generally control the overall operation of system 10, which may include controlling memory 16, a display device 18 (e.g., an electronic display device) that may be connected to server 12, and/or execution of system logic 40. For instance, overall control may be achieved through execution by one or more processors (only one shown) of server 12. In embodiments, processor 14 may include one or more programmable processors, microprocessors, and/or microcontrollers. In addition, processor 14 may include a central processing unit (CPU), memory (in addition to or such as the illustrated memory) and an input/output (I/O) interface through which processor may receive a plurality of input electrical signals including signals, such as generated via a graphical user interface (GUI) 20 and/or other input/output devices. Such an I/O interface may also be configured to generate a plurality of output signals including those used to control and/or provide data to display device 18.

Memory 16 is provided for storage of data, instructions, and/or code (e.g., system logic) and is coupled to at least processor. Memory 16 may include various forms of non-volatile (e.g., non-transitory) memory including flash memory, read only memory (ROM) including various forms of programmable read only memory (e.g., PROM, EPROM, EEPROM) and/or volatile memory such as random access memory (RAM) including static random access memory (SRAM), dynamic random access memory (DRAM), and/or synchronous dynamic random access memory (SDRAM). Although illustrated as a separate component in the illustrated embodiment, it should be understood that memory 16 may be internal to processor 14.

Display device 18 may be configured to display aspects of GUI 20, which may be generated by the operation of system logic 40, such as in connection with a dashboard 190, as described in greater detail below. Display device 18 may function as an input/output device, as noted above, for the user 30 of system 10 and may include components known in the art. Display device 18 may be, for example only, a liquid crystal display or light emitting diode display or other technologies known in the art. Display device 18 may function as only an output device with input received through other I/O devices (e.g., I/O devices 22) such as a keyboard or mouse (not shown). Alternatively, display device 18 may also function as an input device and may include a touch screen display including, for example, capacitive and/or resistive touch screen displays, and/or other technologies known in the art.

System may 10 be connected to a network 24 (e.g., a computer network) by way of a network interface 26. Network 24 may include, for example, an intranet (e.g., a local area network or “LAN”), the internet, a cellular network, and/or other networks.

In embodiments, system logic 40 may include listening module 50. Listening module 50 may be configured to allow system 10 to communicate via one or more electronic communication channels, which may correspond to and/or include internet communication applications. For example, and without limitation, system 10 may be configured to communicate via a first communication channel 60 that may correspond to Google+®, Google® Chat/GChat®, and/or Google Hangouts®; a second communication channel 62 that may correspond to Microsoft® Lync®; a third communication channel 64 that may correspond to Twitter®; and/or a fourth communication channel 66 that may correspond to extensible messaging and presence protocol-based (XMPP-based) services, such as Jabber®. In embodiments, listening module 50 may comprise and/or be located on memory 16, which may include being located in a distinct portion of memory 16 that is separate and apart from portions of memory in which message queue 90 and/or foundation framework 92 may be stored.

In embodiments, listening module 50 may include one or more listeners, such as first listener 52, a second listener 54, a third listener 56, and/or a fourth listener 58, that may be configured to “listen” for data request messages 32_{N} (e.g., data request message 32₁, 32₂, 32₃, 32₄). In embodiments, some or all of data request message 32 may be unrelated to each other. In embodiments, processor 14 may include a processor dedicated to each listener. Each listener of listening module 50 may be located in memory separate and apart from the other listeners, if any, which may allow for each listener to operate independently of other listeners. Each listener may include code, that when executed by processor 14, may preprocess a data request message 32_{N}, which may be referred to herein as a raw or unprocessed data request message 32_{N}, to obtain a preprocessed message 34_{N}. Preprocessing may include authenticating a user 30 from which a raw data request message 32_{N} is received, validating and filtering the raw data request message 32_{N}, transforming the raw data request message 32_{N} to a preprocessed data request message 34_{N}, and/or communicating the preprocessed data request message 34_{N} to message queue 90. Each listener may correspond to and/or be dedicated to a particular communication channel (e.g., channels 60-66).

In embodiments, such as generally illustrated in FIG. 1B, a first listener 52 may be configured to communicate with a Google® server (e.g., a Jabber® server at talk.google.com) and/or may be configured to exchange messages via XMPP. First listener 52 may be configured to communicate via one or more Google® communication methods, such as, for example, Google+®, Google Hangouts®, Google Talk®, and/or Google Chat/GChat®. Second listener 54 may communicate with a Microsoft® Lync® server and/or exchanges messages via the session initial protocol (SIP).

In embodiments, third listener 56 may correspond to Twitter®, and/or may use a Twitter® streaming application program interface (API), a REST API, and/or OAuth for receiving messages via Twitter® (e.g., a Tweet®). For example, and without limitation, third listener 56 may be configured to monitor a company's Twitter® account and “listen” for tweets that include the company's Twitter username/handle, such as “@CompanyABC”. A streaming API may allow access to streams of data (e.g., streams of Tweet® data). A streaming API may be used to for causing messages to be pushed that indicate certain events have occurred (e.g., an incoming Tweet®), without needing to poll for the data (e.g., via polling a REST endpoint). Connecting to a streaming API may include keeping a persistent HTTP connection open. OAuth may be used send secure and/or authorized requests to an API, such as a Twitter® API for application user authentication. A signed request may identify an identity of an application and identify accompanying granted permissions of an end-user that the application is making the API call on behalf of, such as via an access token of the end-user.

In embodiments, Fourth listener 58 may comprise a custom chat listener that may be configured to monitor/listen one or more servers, such as, for example, Jabber servers. In embodiments, more than one (e.g., two or more) listeners may be dedicated to each communication channel.

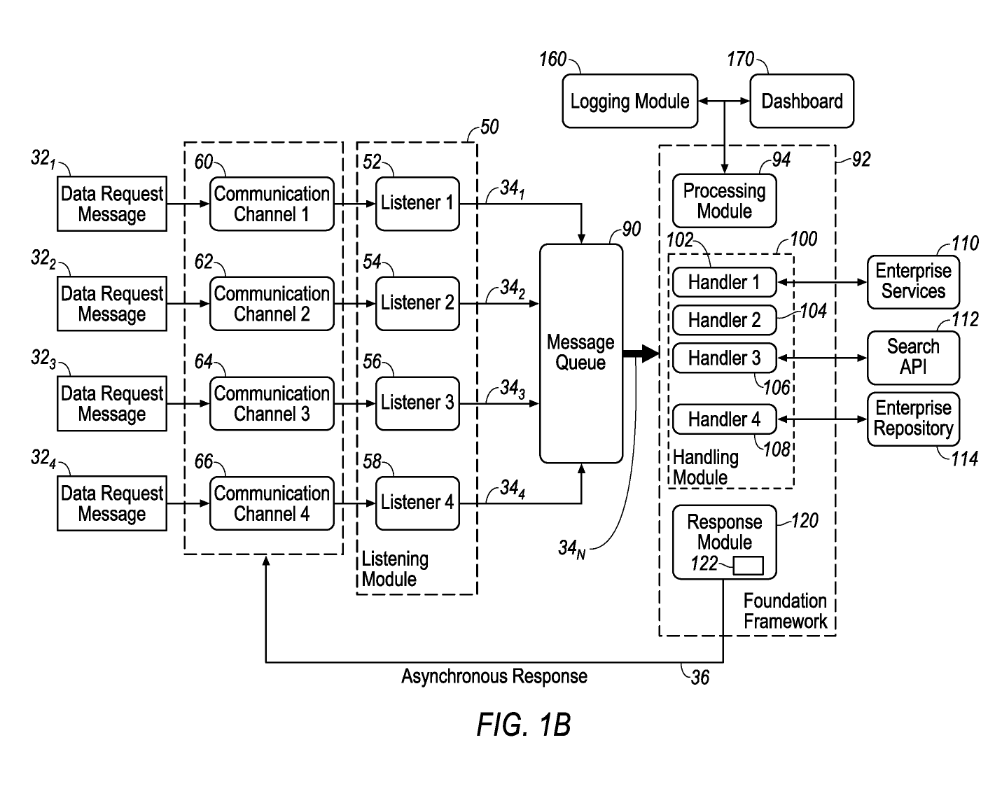

As generally illustrated in FIG. 2A, in a first step 70, each message listener may be configured to receive and/or serialize a raw data request message 32_{N} from a communication channel. Serialization may include converting data from one format to another, such as, for example, from a binary format to an extensible markup language (XML) format and/or to a memory object. Data conversion during serialization may include fields mapping of incoming data to a defined message format. Then, in step 72, a message listener may then filter the received message 32_{N}. Filtering may include applying logic control/conditional rules and/or statements (e.g., if else) to incoming messages. The filtering may depend on the communication channel (e.g., 60, 62, 64, 66) from which the received message 32_{N} is received. If message filtering is not successful, the raw data request message 32_{N} may be discarded in step 74. If message filtering is successful, message listener may then attempt to validate the raw data request message 32_{N} in step 76, which may include determining if the raw data request message 32_{N} is in a proper format and/or was sent by a valid or particular user.

If message validation is not successful, the raw data request message 32_{N} may be discarded in step 78. If message validation is successful, then the message listener may transform the raw data request message 32_{N} in step 80. Message transformation may include loading a canonical message model and/or transforming the raw data request message 32_{N} according to the canonical message model. Transforming a raw data request message 32_{N} according to the canonical message model may include parsing the data request message for information that may fall into one or more of the following categories: a message identification (ID), a created date, a created time, a body of the message, user information, source information, and/or message metadata. For example, and without limitation, a raw data request message 32_{N} may be transformed according to the instructions/code listed in Table 1. Once the message 32_{N} has been transformed, message 32_{N} may be considered as having been preprocessed and/or may be referred to herein as preprocessed message 34_{N} (e.g., raw data request message 32₁ may be preprocessed and become preprocessed message 34₁). Preprocessed messages 34_{N} may sent to message queue 90 in step 82.

TABLE 1

```
<RequestMessage>
      <MessageID></MessageID>
      <CreatedDateTame></CreatedDatertme>
      <Message></Message>
      <UserInfo>
          <UserID></UserID>
          <UserName></UserName>
          <UserScreenName></UserScreenName>
          <Geolocation>
                <Place></Place>
                <Latitude></Latitude>
                <Longitude></Longitude>
          </Geolocation>
      </UserInfo>
      <Source></ Source >
      <MessageMetadata>
          <Hashtag></Hashtag>
          <Channel></Channel>
          <isDirectMessage></isDirectMessage>
          <IsRequest></IsRequest>
          <InReplyUserID></InReplyUserID>
      </MessageMetadata>
</RequestMessage>
```

As generally illustrated above in Table 1, user information may include one or more of a user ID, a user name, a user screenname, and/or a user geolocation. A user geolocation may include a place (e.g., the name of a city, state, country, building, etc.), a latitude, and/or a longitude. Message metadata may include hashtag information (e.g., whether the message includes a hashtag and/or how many hashtags are included in the message), a channel, a direct message indicator that may correspond to whether the data request message is a direct message, an indicator of whether the data request message is a request, and/or a user ID for replies and/or responses (e.g., a response 36).

In embodiments, transforming received data request messages 32_{N}, some or all of which may be received from different channels and/or in different formats, may allow all received messages 32_{N} to be efficiently placed in a single message queue (e.g., message queue 90) as preprocessed messages 34_{N} and/or for each message listener to be independent from each other message listener. Independent message listeners may allow for one or more of the message listeners to fail without causing the entire message listening module 50 to fail. Additionally or alternatively, independent message listeners may allow for efficiently making changes. For example, and without limitation, changes may be applied to a particular listener without affecting the other listeners (e.g., without modifying other listeners or taking other listeners offline). In embodiments, listening module 50 may be loosely coupled with foundation framework 92. A loosely coupled arrangement may include connecting listening module 50 with foundation framework 92 via a configuration file 138, so that listening module 50 and foundation framework 92 are indirectly linked to each other. A loosely coupled configuration may permit changes to be made to listening module 50 without requiring changes to be made to foundation framework 92, which may allow for changes to be made more efficiently. For example, and without limitation, adding a new listener to listening module 50 to accommodate a new communication channel may not require any changes to foundation framework 92.

In embodiments, message listening module 50 may be connected to foundation framework 92 for asynchronous communication. For example, and without limitation, once a listener receives a data request message 32_{N} and preprocesses the message (e.g., via user authentication, validation, filtering, and/or transformation), listening module 50 may communicate the preprocessed message 34_{N} to message queue 90. Then, message handling module 100 may handle preprocessed data request messages 34_{N} in the order the data request messages 34_{N} were provided to message queue 90, which may not necessarily be the same order or at the same time as corresponding data request messages 32_{N} were received by listening module 50. For example, and without limitation, certain listeners (e.g., listeners 52, 54, 56, 58) of listening module 50 may operate faster than other listeners. Such asynchronous communication may permit system 10 to be more efficient than conventional systems. As generally illustrated in FIG. 2B, for example, and without limitation, system 10 may first receive a first data request message 32₅ on first communication channel 60 and then receive second and third data requests messages 32₆, 32₇ on second communication channel 62. If listener 52 preprocesses the first data request message 32₅ slower than listener 54 preprocesses the second and/or third data request messages 32₆, 32₇, the second and/or third data request messages 32₆, 32₇ may be communicated to message queue 90 as preprocessed data request messages 34₆, 34₇ before the first data request message 32₅ is transmitted as preprocessed data request message 34₅, even though system 10 received the first message 32₅ before the second and third data request messages 32₆, 32₇. Thus, the second and third messages 32₆, 32₇ may be preprocessed without waiting for first listener 52 to preprocess the first data request message 32₅ and may be preprocessed faster than in conventional systems. Preprocessing of multiple data request messages may be accomplished by multiple listeners simultaneously. Such preprocessing, among other things, may permit system 10 to be more efficient than conventional systems, such as systems that use a first-in-first-out (FIFO) strategy.

In embodiments, a message queue 90 may be configured to receive data request messages, such as preprocessed messages 34_{N}, from listening module 50. Message queue 90 may be stored in a separate portion of memory 16 apart from listening module 50 and/or foundation framework 92, but may be in communication with listening module 50 and foundation framework 92. Message queue 90 may store (e.g., asynchronously) a plurality of preprocessed data request messages 34_{N} that may have been received via different communication channels and may store the messages 34_{N} in the same format (e.g., in accordance with Table 1), regardless of the communication channel from which corresponding raw messages 32_{N} were original received.

With continued reference to FIG. 1, system logic 40 may include foundation framework 92 that may include a message processing module 94, a message handling module 100, and/or a response module 120.

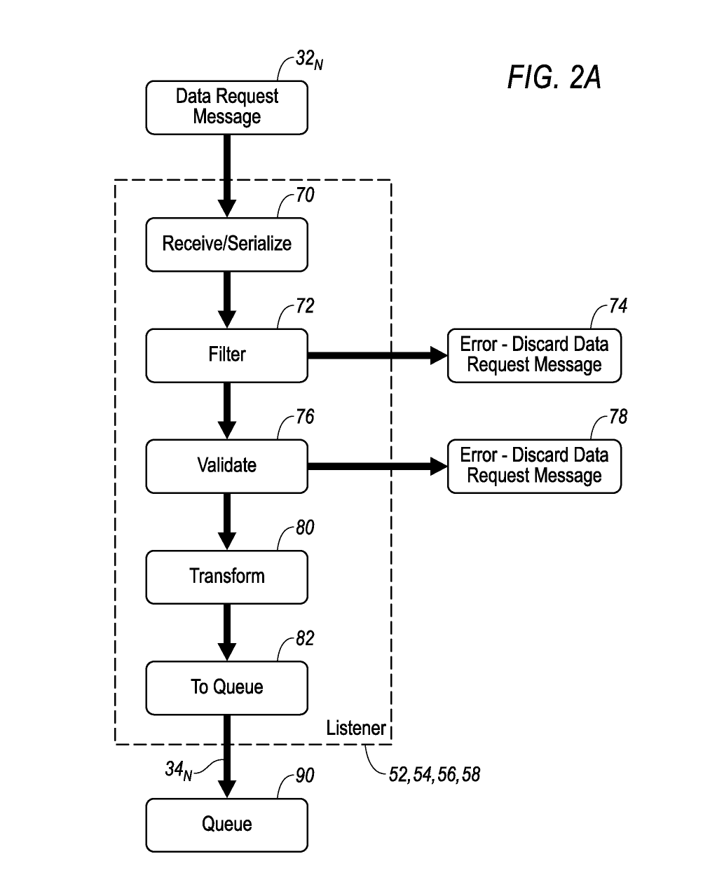

In embodiments, such as generally illustrated in FIGS. 1B and 3, system logic 40 may include a message processing module 94. Message processing module 94 may be configured to retrieve messages 34_{N} from message queue 90 and provide the retrieved messages 34_{N} to a message handler (e.g., message handlers 102, 104,106, 108) of a message handling module 100. Context of raw messages 32_{N} may be maintained throughout system, including if raw messages 32_{N} become preprocessed messages 34_{N}. Maintaining context may, among other things, allow response module 120 to send a response 36 to the user 30 that submitted the message 32_{N}. Context may include metadata of the data request message 32_{N}, which may include message source, message owners, request type, and/or response type, among others.

Message processing module 94 may be coupled to foundation framework 92 at runtime via a configuration file 138. For example, and without limitation, such as generally illustrated in Table 2, foundation framework 92 may be implemented via a Unity container that may be disposed in configuration file 138. Configuration file 138 may include a name of a message processing module 94 and/or a library name, either or both of which may be disposed in a Unity container.

```
TABLE 2
<unity>
    <typeAliases>
      <typeAlias alias=“singleton”
type=“Microsoft.Practices.Unity.ContainerControlledLifetime
Manager, Microsoft.Practices.Unity”/>
      <typeAlias alias=“external”
type=“Microsoft.Practices.Unity.ExternallyControlledLifetime
Manager, Microsoft.Practices.Unity”/>
    </typeAliases>
    <containers>
      <container name=“ASMIContainer”>
        <types>
          <type
type=“ASMIFramework.System.Contract.IMessageHandler,
ASMIFramework.System.Contract”
      mapTo=“ASMIFramework.System.Handlers.MessageHandler,
ASMIFramework.System” />
        </types>
      </container>
    </containers>
  </unity>
```

Such an arrangement between message processing module 94 and foundation framework 92 may correspond to dependency inversion, and may allow for configuration and injection of custom processing modules without changing foundation framework 92. Foundation framework 92 may delegate messages via a strategy design pattern that may allow for determining the behavior of processing module 94 at runtime. Foundation framework may record all incoming data request messages 32_{N}, preprocessed messages 34_{N}, and/or all responses 36 sent, such as for auditing purposes.

With continued reference to FIG. 3, in embodiments, system logic 40 may include a message handling module 100 that may be connected to and/or located in foundation framework module 92. Message handling module 100 may be configured to execute requests and/or obtain the data requested by data request messages 32_{N} and/or preprocessed data request message 34_{N}. Message handling module 100 may include one or more message handlers, such as a first handler 102, a second handler 104, a third handler 106, and/or a fourth handler 108. Each message handler may operate entirely independently from each other message handler, which may include being compiled and deployed as separate components stored in different parts of memory 16. Thus, if changes are made to one message handler that may be stored in a first part of memory 16, a second message handler that may be stored in a second part of memory may not be affected. Each message handler may be added to the message handling module 100 and/or connected to the message handling module 100 via dynamic discovery using configurations files and reflection. Dynamic discovery may, for example, be implemented via a Unity container, which is a Microsoft® framework. Dynamic discovery may allow new modules to be added/injected even if the system 10 is running.

In embodiments, first message handler 102 may include a command handler and/or may be referred to herein as command handler 102. Command handler 102 may be configured to carry out predefined data requests. For example, and without limitation, a raw data request message 32_{N} may include a predefined command, such as “#help”, which may correspond to a request by a user 30 for a list of help options via a particular communication channel and/or from a particular company. In another example of the present disclosure, a predefined command may be combined with other information. For example, a raw data request message 32_{N} may include “#NewPolicy, car, 25, 1” which may correspond to a quote for a car insurance quote for a 25 year-old person, for 1 year. Thus, a raw data request message 32_{N} may also include unique information and/or parameters provided by the user in addition to a predefined commands. In a further example, a user 30 may not know what information is used for a particular command, so system logic 40, via foundation framework 92, may be configured to send responses 36 with one or more follow-up requests to the user for additional information. For example, and without limitation, if a user 30 only sends “#NewPolicy” as a raw data request message 32_{N}, foundation framework 92 may be configured receive a corresponding preprocessed message 34_{N} and to send a response 36 with a request for the user 30 to submit an additional raw data request message 32_{N} that includes the type of policy, the age of the policyholder, and the proposed term. Additionally or alternatively, each additional piece of information may be requested via a separate response 36 once a satisfactory message is received from the user 30. Command handler 102 may be connected to enterprise services 110 that may correspond to the various predefined commands that command handler 102 may be configured to receive.

Second handler may 104 include a natural language handler and/or may be referred to herein as natural language handler 104. Natural language handler 104 may be configured to interpret data request messages 32_{N}, such as messages 32_{N} that may not conform to predefined commands. For example, and without limitation, if a data request message includes a request “what is the nearest ATM location,” command handler 102 may not be able to process the request if that particular string is not associated with a predetermined command. Natural language handler 104 may be configured to process such a message and allow system 10 to provide a response 36. Natural language handler 104 may be implemented via the artificial intelligence markup language (AIML). Natural language handler 104 may be connected to one or more other modules, such as third handler 106 and/or fourth handler 108 for handling certain data request messages 34_{N}, such as messages 34_{N} that may not be able to be handled/interpreted by natural language handler 104 alone.

In embodiments, third handler 106 may include an internet search handler and/or may be referred to herein as internet search handler 106. Internet search handler 106 may be configured to search the internet, such as via a search API 112 (e.g., Google® search APIs), for the data requested in a data request message 34_{N} and/or to determine the meaning of a request before executing the request or passing the request to another handler for execution.

In embodiments, fourth handler 108 may include enterprise search handler and/or may be referred to herein as enterprise search handler 108. Enterprise search handler 108 may be connected to an enterprise repository 114 that may include enterprise-wide knowledge databases of data that may subject to requests. Enterprise search handler 108 may search through the enterprise repository 114 for data that at least partially matches data requested by the preprocessed data request message 34_{N}. Enterprise repository may include, for example, exception details, customer names and biographical information, and/or application names.

In embodiments, message handling module 100 may include more than one of a particular message handler, which may allow for faster handling of messages 34_{N}. For example, and without limitation, message handling module 100 may include a plurality of command handlers 102, which may allow system to simultaneously handle a plurality of command-type messages (e.g., messages including predefined commands).

Referring again to FIG. 3, in embodiments, system logic 40 may include a response module 120. Once data requested by a preprocessed data request message 34_{N} is obtained, such as via message handling module 100, the obtained data may be communicated to response module 120. Response module 120 may include one or more independent responders 122 that may each be dedicated to a particular communication channel, which may allow system to provide responses to data request messages 32_{N} and/or preprocessed data request messages 34_{N} via a plurality of communication channels. In embodiments, response module 120 may be configured to send a response 36 to a raw data request message 32_{N} via a different communication channel than the communication channel from which the raw data request message 32_{N} was received, the same communication channel, and/or a combination of the same and different channels.

In embodiments, response module 120, such as via responders 122, may be configured to transform the obtained data to a form compatible with a desired response communication channel (e.g., the communication channel from which the corresponding data request message was received). For example, and without limitation, if a raw data request message 32_{N} was received via third communication channel 64 (e.g., via Twitter®), response module may transform the obtained data into one or more 140 character messages. Once the data has been transformed, response module 120 may communicate the data to the requester (e.g., send a response 36 to user 30) via the response communication channel. In embodiments, response module 120 may include at least one responder 122 that corresponds to each communication channel (e.g., at least one responder for each of channels 60, 62, 64, 66).

In embodiments, such as generally illustrated in FIG. 3, a method of data communication may include, in step 130, message processing module 94 retrieving a preprocessed data request message 34_{N} from the message queue 90. In step 132, message processing module 94 may then deserialize the message 32_{N} and/or convert the message to a message object. Deserializing a message may include similar operations as serializing a message, but may be performed in reverse. In step 134, message processing module 94 may analyze the message 32_{N} and, in step 136, may select a message handler from message handling module 100 for executing the data request. Message analysis in step 134 and/or handler selection in step 136 may be conducted in accordance with a configuration file or files 138. In step 140, the selected message handler may execute the request and/or obtain the requested data. The selected message handler may communicate with a data store 150 and/or a web service 152 to execute the request or obtain the requested data. In step 154, the selected message handler may communicate the requested data to the response module 120. A web service may include an internet and/or intranet portal that may be accessed by an employee and/or a customer. In step, the response module 120 may transform the data into a format compatible with the response communication channel and communicate the response to the user 30 that submitted the raw data request message 32_{N}.

In embodiments, system logic 40 may include a logging module 160. Logging module 160 may be configured to log received data request messages 32_{N} and responses 36 sent by response module 120 to a database, which may include the enterprise database and/or a database stored in memory. Additionally or alternatively, logging module 160 may be configured to maintain audit and history information (e.g., incoming and outgoing messages) and/or error and exception details that may be used for monitoring the health of system 10.

Referring back to FIG. 1B, in embodiments, system logic 40 may include a dashboard module 170. Dashboard module 170 may be configured to provide a web-based application for providing information on some or all of the received data request messages 32_{N} and the responses 36 made thereto. Geographic location information may be displayed in connection with received data request messages 32_{N}, if available, such as for better visibility and tracking. The web-based application may include a display of errors and/or exceptions.

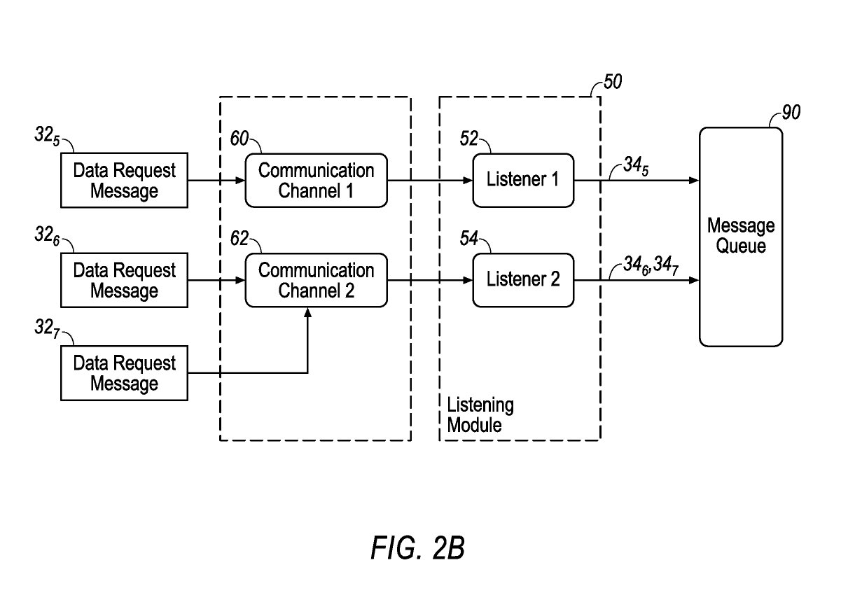

In an embodiment, such as generally illustrated in FIG. 4, system 10 may be used in connection with a company's employees requesting data from the company. For example, and without limitation, an employee insurance agent 200 may send a raw data request message 32_{N} to the company via second communication channel 62 (e.g., Microsoft® Lync®) to obtain an insurance premium estimate from the company. The raw data request message 32_{N} may include a predefined command (e.g., “#NewPolicy”) and/or information about a proposed policy (e.g., type, age, term). For example, the raw data request message 32_{N} may include “#NewPolicy, car, 25, 0.5” which may correspond to a quote for a car insurance quote for a 25 year-old person, for 6 month (e.g., 0.5 of one year). System 10 may receive the data request message via a listener, the listener may communicate the message 32_{N} to the message queue 90, and the message 32_{N} may be processed, handled, and responded to via foundation framework 92, such as generally described above in connection with FIGS. 1B, 2A, 2B, and 3.

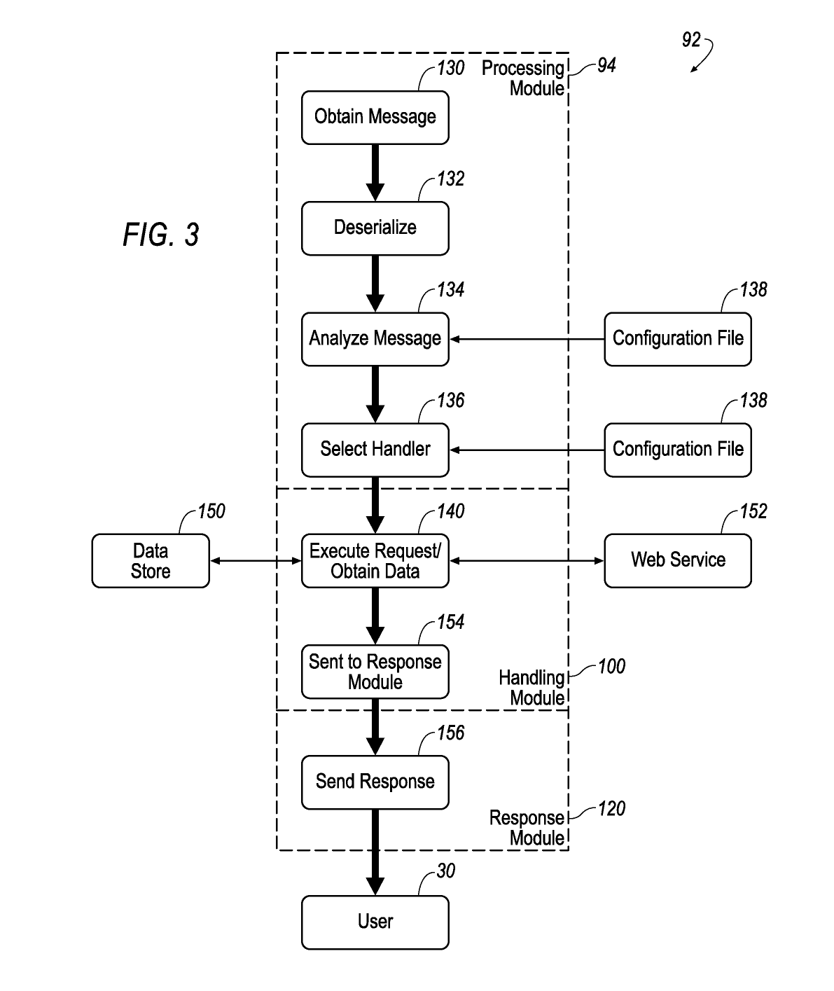

In another embodiment, such as generally illustrated in FIG. 5, system 10 may be used in connection with a company's employee 200 and a customer 202 of the company. For example, and without limitation, a customer 202 may be policyholder of an insurance company that submits a first data request message to the company, such as a request for a list of help options available via third communication channel 64 (e.g., Twitter®). The insurance company may have one or more Twitter® usernames, such as, for example, “@InsuranceCo”. The policyholder may, for example, send the first data request message 32_{N} in the form of a tweet that includes “@InsuranceCo” and “#help”. System 10 may receive the tweet via third listener (which may be dedicated to Twitter® and “listen” for tweets that include “@InsuranceCo”), the listener may communicate the tweet to the message queue 90, and foundation framework may execute the request (e.g., via command handler 102) and send a response 36 to the policyholder 202 with a list of help options. The policyholder 202 may then send a second data request message 32_{N} in the form of a second tweet that includes one of the listed help options, such as “#CallMe”. System 10 may again process the tweet in a similar manner as the first tweet, and may send an acknowledgement to the policyholder 202 that the tweet/data request message 32_{N} was received. System 10 may simultaneously send a message over the same and/or a different communication channel (e.g., Microsoft® Lync®) to a company employee 200 (e.g., an insurance agent) that includes the policyholder's request for a call and contact information of the policyholder 202. The message to the company employee 200 may also be sent prior to or after the acknowledgement is sent to the policyholder 202. The contact information may be retrieved by system from enterprise repository 114. The agent 200 may then contact the policyholder 202 using the contact information via the communication channel used by the policyholder, by the company, and/or a different communication channel. The contact information may include, for example, a phone number or a username for a messaging and/or video chat services (e.g., Google+Hangouts®). In some situations, the agent 200 may be able to contact the policyholder 202 in response to a data message request 32_{N}, such as “#CallMe”, within 30 seconds.

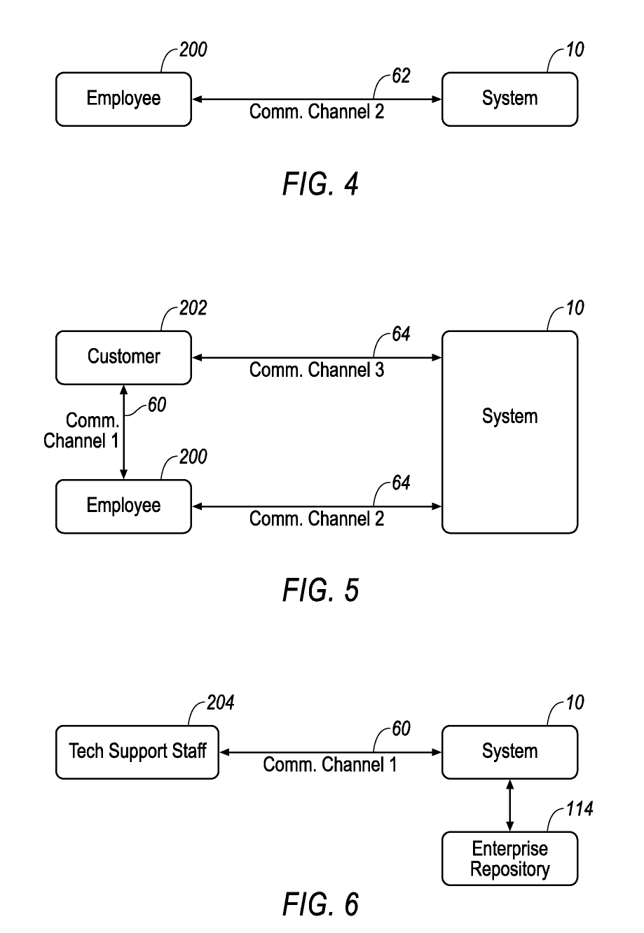

In another example of the present disclosure, such as generally illustrated in FIG. 6, system 10 may be used in connection with a company's technical support staff 204, which may allow the technical support staff 204 to more efficiently obtain useful information for solving problems encountered by other employees (e.g., submitted via support tickets). A member of the technical support staff 204 may be able to send information from a support ticket to the system 10 in a data request message 32_{N}, such as via Microsoft Lync®. System 10 may then search an enterprise repository 114, which may be a big data platform, for additional information. A big data platform may include, for example, Splunk®, Logstash™, Kibana®, and/or Elasticsearch®. The enterprise repository 114 may include records of similar problems and/or may provide additional details regarding the circumstances of the support tickets, such as, exception or other details that may have been logged into the enterprise repository 114, such as by the company's enterprise software. System 10 may then send relevant information back the technical support staff member 204 so that the support ticket may be resolved more efficiently.

In embodiments, system logic 40 may be configured to allow system 10 to be scalable, such as via independence of various components and/or loose coupling between various components. For example, and without limitation, additional listeners may be added for new or different communication channels, such as email and/or short message service (SMS).

It should be understood that a system and/or a processor as described herein may include a conventional processing apparatus known in the art, capable of executing preprogrammed instructions stored in an associated memory, all performing in accordance with the functionality described herein. To the extent that the methods described herein are embodied in software, the resulting software can be stored in an associated memory, such as memory, and can also constitute the means for performing such methods. Such a system or processor may further be of the type having both ROM, RAM, a combination of non-volatile and volatile (modifiable) memory so that any software may be stored and yet allow storage and processing of dynamically produced data and/or signals.

It should be further understood that an article of manufacture in accordance with this disclosure includes a non-transitory computer-readable storage medium having a computer program encoded thereon for implementing the system logic and other functionality described herein. The computer program includes code to perform one or more of the methods disclosed herein. Such embodiments may be configured to execute one or more processors, multiple processors that are integrated into a single system or are distributed over and connected together through a communications network, and/or where the network may be wired or wireless. Code for implementing logic may, when executed by a processor, cause a plurality of transistors to change from a first state to a second state. A specific pattern of change (e.g., which transistors change state and which transistors do not), may be dictated, at least partially, by the logic and/or code. For example, and without limitation, in embodiments, processor of system may include a plurality of transistors that change state according to system logic and/or code that implements system logic.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. Additionally, the terms “communicate” and “communication” are meant to be construed broadly to encompass both wired and wireless connections and communications. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure as defined in the appended claims.

What is claimed is:

1. A data communication system, comprising:
a computer server comprising:
a processor;
a memory; and
a computer program encoded on said memory, said computer program configured to implement system logic, said system logic including:
a listening module stored in a first part of the memory and configured to monitor a plurality of different electronic communication channels for data request messages;
a message queue stored in a second part of the memory and including asynchronously stored data request messages received from the listening module; and
a foundation framework stored in a third part of the memory, the foundation framework configured to obtain data request messages from the message queue and process, execute, and respond to the obtained data request messages.

2. The system of claim 1, wherein the listening module includes a plurality of independent listeners, and each of the plurality of listeners is independent from the other listeners such that if one or more of the plurality of listeners malfunctions, the malfunctioning message listener or listeners does not affect other listeners.

3. The system of claim 2, wherein at least one listener of the plurality of listeners is connected to each of the plurality of different communication channels.

4. The system of claim 2, wherein at least two listeners of the plurality of listeners is connected to each of the plurality of different communication channels.

5. The system of claim 2, wherein each of the plurality of listeners is configured to independently and simultaneously serialize, filter, validate, and transform at least some of the data request messages received by the listening module.

6. The system of claim 1, wherein the foundation framework includes a message handling module that includes a plurality of independent message handlers; and, the plurality of message handlers includes a predefined command handler, a natural language handlers, an internet search handler, and an enterprise search handler.

7. The system of claim 1, wherein foundation framework includes a response module that includes a plurality of responders, and at least one responder of the plurality of responders is configured to send one or more responses to the plurality of data request messages via a respective one of each of the plurality of communication channels.

8. A method for high efficiency data communications via a computer network, the method comprising:
providing a computer server including a processor and a memory coupled to the processor;
receiving, via a listening module executed by the processor and stored in a first part of the memory, a plurality of unrelated data request messages from a plurality of different electronic communication channels of the computer network;
asynchronously storing the plurality of data request messages in a message queue stored in a second part of the memory;
obtaining data requested in the data request messages via a foundation framework executed by the electronic processor and stored in a third part of the memory; and
sending, via a response module executed by the electronic processor and stored in a fourth part of the memory, responses to the plurality of data request messages via one or more of the plurality of different communication channels.

9. The method of claim 8, wherein the listening module includes a plurality of independent listeners; each of the plurality of listeners is independent from the other listeners such that if one or more of the plurality of listeners malfunctions, the malfunctioning message listener or listeners does not affect the other listeners.

10. The method of claim 8, wherein at least two listeners of the plurality of listeners are connected to each of the plurality of different communication channels.

11. The method of claim 8, wherein each of the plurality of communication channels corresponds to an internet-based communication application.

12. The method of claim 8, wherein the plurality of different communication channels includes channels corresponding to each of Twitter®, Google®, and Microsoft® Lync®.

13. The method of claim 9, further comprising simultaneously serializing, filtering, validating, and then transforming at least two of the data request messages via the plurality of listeners.

14. The method of claim 8, comprising discarding one or more of the plurality of data request messages received by the listening module if the one or more of the plurality of listeners fails to filter or validate the one or more of the plurality of data request messages.

15. The method of claim 8, wherein the foundation framework includes a message processing module, a message handling module, and the response module.

16. The method of claim 15, wherein the message handling module include a predefined command handler, a natural language handlers, an internet search handler, and an enterprise search handler.

17. The method of claim 16, wherein each of the predefined command handler, the natural language handlers, the internet search handler, and the enterprise search handler are disposed in separate parts of the memory and operate independently of each other.

18. The method of claim 15, wherein the message handling module is loosely coupled to the foundation framework via a configuration file.

19. The method of claim 8, further comprising displaying on a display geographic information from one or more of the plurality of data message requests.

20. The method of claim 8, wherein the response module includes a plurality of responders, and at least one responder is configured to send one or more of the responses via a respective one of each of the plurality of communication channels.
